(19) United States
(12) Patent Application Publication
(10) Pub. No.: US 2024/0152025 A1
(43) Pub. Date: May 9, 2024

(54) Optical Wavelength Conversion Device

(71) Applicant: Nippon Telegraph and Telephone Corporation, Tokyo (JP)

(72) Inventors: Takahiro Kashiwazaki, Musashino-shi, Tokyo (JP); Takushi Kazama, Musashino-shi, Tokyo (JP); Takeshi Umeki, Musashino-shi, Tokyo (JP); Osamu Tadanaga, Musashino-shi, Tokyo (JP); Koji Embutsu, Musashino-shi, Tokyo (JP); Nobutatsu Koshobu, Musashino-shi, Tokyo (JP); Asuka Inoue, Musashino-shi, Tokyo (JP); Kei Watanabe, Musashino-shi, Tokyo (JP)

(21) Appl. No.: 18/548,815

(22) PCT Filed: Apr. 12, 2021
(86) PCT No.: PCT/JP2021/015229

§ 371 Date: Sep. 1, 2023

(51) Int. Cl. G02F 1/377; G02F 1/35; G02F 1/355

(52) U.S. Cl. CPC G02F 1/3775; G02F 1/3548; G02F 1/3558

(57) ABSTRACT

In a nonlinear optical element, wavelength conversion efficiency is degraded by the heat generation caused when high-intensity converted waves are generated. Therefore, the present invention provides a wavelength conversion optical element that includes a periodically poled waveguide. In the wavelength conversion optical element, the periodically poled waveguide includes: a core that performs wavelength conversion on a fundamental wave that has entered the entrance end, and emits a converted wave from the exit end; and a cladding that covers the periphery of the core, and the structure of the element gradually changes so as to achieve quasi phase matching from the entrance end toward the exit end in the periodically poled waveguide.

### TECHNICAL FIELD

The present invention relates to an optical element using a nonlinear optical effect, and more specifically, to a wavelength conversion optical element to be used in an optical communication system or an optical measurement system.

### BACKGROUND ART

Optical application technologies using nonlinear optical effects are expected in new optical communication fields, quantum information communication fields using light, optical measurement system fields, and the like. Wavelength conversion is known as the fundamental effect among nonlinear optical effects. This wavelength conversion is a technique for converting light entering a nonlinear optical medium into light having another wavelength. Because of such characteristics, wavelength conversion has been widely put into practical use as a technique for generating light in a wavelength band that is difficult to oscillate with a laser alone.

In the description below, the principles of wavelength conversion in a nonlinear optical effect are explained. As a nonlinear optical effect, light having wavelengths λ₁ and λ₂ is input, and new light having a wavelength λ₃ is generated. The wavelength conversion satisfying (Equation 1) shown below is called sum frequency generation (hereinafter referred to as SFG). In addition to that, the wavelength conversion in a case where λ₁=λ₂ (that is, (Equation 2) is satisfied) is called second harmonic generation (hereinafter referred to as SHG).

1/λ₃=1/λ₁+1/λ₂ (Equation 1)

λ₃=λ₁/2 (Equation 2)

Meanwhile, the wavelength conversion satisfying (Equation 3) is called difference frequency generation (hereinafter referred to as DFG).

1/λ₃=1/λ₁−1/λ₂ (Equation 3)

Further, it is also possible to input only light having the wavelength λ₁, and generate other light (light having the wavelength λ₂ and light having the wavelength λ₃) satisfying the relationship shown in (Equation 3) (this effect is called an optical parametric effect). Particularly, SHG and SFG are used in various kinds of technologies, to newly generate light of a shorter wavelength (which is high-energy light) relative to the input light. For example, in a case where phase sensitive amplification is to be achieved through optical parametric amplification, signal light and strong excitation light are required, and SHG is used as a means for generating the excitation light.

To efficiently cause these nonlinear optical effects, the amount of phase mismatch among the three wavelengths interacting with one another needs to be zero. One means for achieving this is to set the phase mismatch amount to zero in a simulative manner by periodically inverting the polarization of a nonlinear optical material (that is, a periodically poled structure is adopted). Where the inversion period is represented by Λ, the inversion period Λ satisfying (Equation 4) shown below is set for the light having the wavelengths λ₁, λ₂, and λ₃ in SFG expressed by (Equation 1), and the phase mismatch amount can be set to zero in a simulative manner.

n₃/λ₃−n₂/λ₂−n₁/λ₁−1/Λ=0 (Equation 4)

Here, n₁ represents the refractive index at the wavelength λ₁, n₂ represents the refractive index at the wavelength λ₂, and n₃ represents the refractive index at the wavelength λ₃.

In addition to the adoption of such a periodically poled structure, a wavelength conversion optical element is turned into a waveguide (which is a periodically poled waveguide), so that highly efficient wavelength conversion can be performed. A nonlinear optical effect becomes greater, as the density of light overlaps that causes a nonlinear interaction becomes higher. Therefore, a periodically poled waveguide capable of confining light in a waveguide having a small cross-sectional area and guiding light over a long distance is adopted to enable highly efficient wavelength conversion.

In particular, periodically poled waveguides that use lithium niobate (LiNbO₃), which is a nonlinear optical material and has a large nonlinear constant, are adopted in light sources already commercially available because of their high wavelength conversion efficiencies, and are being put into practical use.

Conventionally, a technique that uses Ti diffusion or proton exchange is normally adopted to form a waveguide structure using a nonlinear optical material. In recent years, however, ridge optical waveguides have been developed. A ridge optical waveguide can use bulk characteristics of a crystal as a wavelength conversion optical element, and has characteristics such as a high tolerance to optical damage, long-term reliability, and ease of device design (see Non Patent Literature 1, for example). This ridge optical waveguide is formed by bonding two substrates, making one of the substrates thinner, and further performing ridge processing. A direct bonding technique is known as a technique for firmly bonding the substrates to each other without use of any adhesive or the like at the time of bonding the substrates. A direct-bonded ridge waveguide to which this technology is applied can receive strong light, and has successfully reduced its core size with the progress of the waveguide technology, and its wavelength conversion efficiency has been steadily increasing (see Non Patent Literature 2, for example).

To achieve a high conversion efficiency in a waveguide nonlinear optical element, it is necessary to maintain phase matching between a fundamental wave as input light and a converted wave as output light over a long distance in the waveguide. In a region where low-intensity light propagates in the waveguide, a uniform phase matching condition is required to be maintained in the longitudinal direction of the waveguide. This is achieved with a uniform waveguide structure and uniform polarization inversion periods in a periodically poled waveguide using a nonlinear optical material. In a structurally uniform waveguide, however, the phase matching condition collapses in a region where a high-intensity converted wave is generated, and therefore, the wavelength conversion efficiency is degraded. This is because the generated converted wave is more easily absorbed by the waveguide medium than the fundamental wave, heat is generated by light absorption in the waveguide, and, as a result, a temperature-induced change or the like is caused in the refractive index. Since the amount of the heat generation has a positive correlation with the intensity of the propagating converted wave, a temperature distribution is generated so that the temperature of the waveguide rises as approaching the exit end at which the intensity of the converted wave propagating inside is higher. As described above, a nonlinear optical element has the problem of wavelength conversion efficiency degradation caused by the heat generation at the time of generation of a high-intensity converted wave.

As methods for solving such a problem, conventional technologies include a technique for adjusting the temperature of an entire element so that the temperature of the element becomes constant, and a technique for controlling the temperature gradient by installing a heater in the vicinity of the element. However, these techniques increase the number of steps in manufacturing an element, and increase the number of control systems, which complicates the structure of an element.

### CITATION LIST

### Non Patent Literature

Non Patent Literature 1: Y. Nishida, H. Miyazawa, M. Asobe, O. Tadanaga, and H. Suzuki, “Direct-bonded QPM-LN ridge waveguide with high damage resistance at room temperature,” Electronics Letters, Vol. 39, No. 7, pp. 609-611 (2003)

Non Patent Literature 2: T. Umeki, O. Tadanaga, and M. Asobe, ‘Highly Efficient Wavelength Converter Using Direct-Bonded PPZnLN Ridge Waveguide,’ IEEE Journal of Quantum Electronics, Vol. 46, No. 8, pp. 1206-1213 (2010)

### SUMMARY OF INVENTION

The present invention is a technique for solving the above problems, and aims to enable highly efficient generation of high-intensity converted waves.

To achieve the above objective, an embodiment of the present invention provides a wavelength conversion optical element that includes a periodically poled waveguide. In the wavelength conversion optical element, the periodically poled waveguide includes: a core that performs wavelength conversion on a fundamental wave that has entered the entrance end, and emits a converted wave from the exit end; and a cladding that covers the periphery of the core, and the structure of the element gradually changes so as to achieve quasi phase matching from the entrance end toward the exit end in the periodically poled waveguide.

According to the present invention, the wavelength conversion optical element as described above enables highly efficient generation of high-intensity converted waves. Further, there is an effect of being able to contribute to reduction of the device manufacturing processes and simplification of the element structure as compared with conventional technologies.

### BRIEF DESCRIPTION OF DRAWINGS

FIG. 1 is a diagram illustrating a periodically poled waveguide having a structure in which the polarization inversion period of the core is gradually changed.

FIG. 2 is a diagram illustrating a periodically poled waveguide having a structure in which the width of the core is gradually changed.

FIG. 3 is a diagram illustrating a wavelength conversion optical element having a structure in which the polarization inversion period is gradually changed.

FIG. 4 is a diagram illustrating a wavelength conversion optical element in which the width of the core is gradually changed.

FIG. 5 is a diagram illustrating a wavelength conversion optical element having a structure in which the polarization inversion period is gradually changed.

FIG. 6 is a diagram illustrating a wavelength conversion optical element in which the refractive index of the core is gradually changed.

### DESCRIPTION OF EMBODIMENTS

A wavelength conversion optical element according to an embodiment of the present invention is a periodically poled waveguide that generates high-order harmonic light from an incident fundamental wave, and emits desired wavelength-converted light from the exit end of the element. However, the phase matching condition differs from that according to a conventional technology in that the phase matching condition changes gradually in the direction from the entrance end toward the exit end. As described above, in a periodically poled waveguide that generates a high-intensity converted wave, the temperature of the element becomes higher from the entrance end toward the exit end. Therefore, this embodiment provides a technology for reducing phase mismatch due to heat generation generated by a gradual change in the function of a wavelength conversion optical element and enabling generation of converted waves with high efficiency so that phase matching in terms of the phase matching condition can be achieved in a higher-temperature environment at a portion closer to the exit end than to the entrance end.

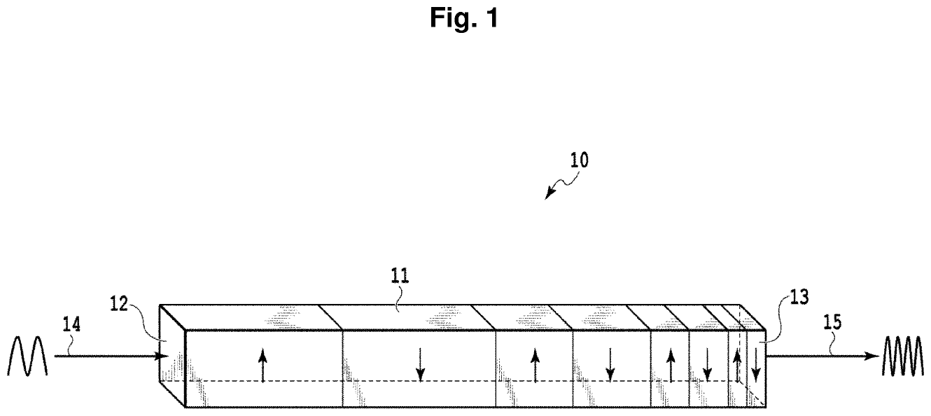

FIG. 1 is a diagram illustrating a periodically poled waveguide having a structure in which the polarization inversion period of the core is gradually changed according to an embodiment of the present invention. This drawing illustrates the core portion of a periodically poled waveguide, and the waveguide may be either a ridge optical waveguide or a buried waveguide. Note that, in a case where the periodically poled waveguide is a ridge optical waveguide or the like, at least part of the cladding that covers the periphery of the core is an air layer. A periodically poled waveguide 10 includes: a core 11 that performs light wavelength conversion; an entrance end 12 at which fundamental light 14 enters on one end side; and an exit end 13 from which a converted wave 15 subjected to the wavelength conversion performed by the core 11 is emitted on the opposite end side. In this structure, the polarization inversion period becomes gradually shorter from the entrance end 12 toward the exit end 13. That is, in the direction of the optical axis of the periodically poled waveguide 10, the length of a region in which polarization is set in one direction becomes gradually shorter from the entrance end 12 toward the exit end 13.

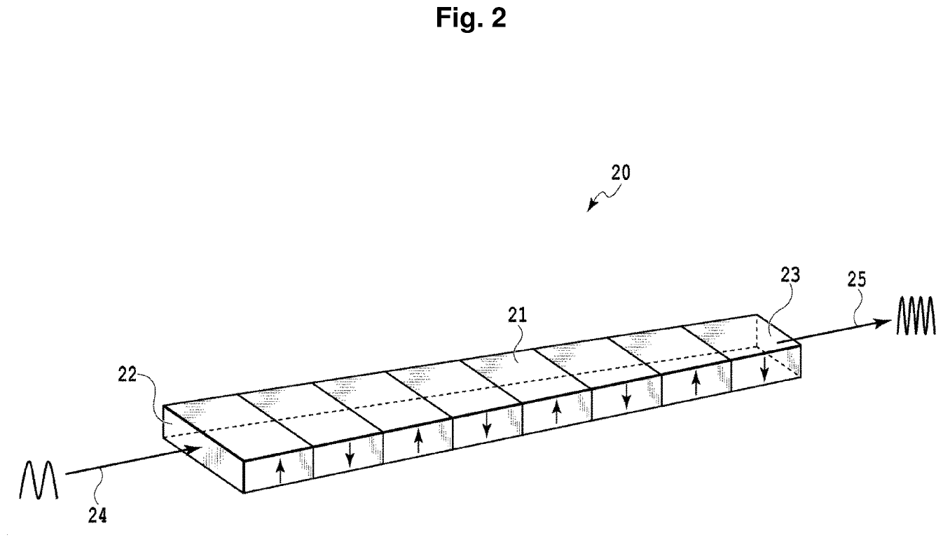

FIG. 2 is a diagram illustrating a periodically poled waveguide having a structure in which the width of the core is gradually changed according to an embodiment of the present invention. A periodically poled waveguide 20 includes: a core 21 that performs light wavelength conversion; an entrance end 22 at which fundamental light 24 enters; and an exit end 23 from which a converted wave 25 subjected to the wavelength conversion performed by the core 21 is emitted. In this structure, the width of the core 21 becomes gradually shorter from the entrance end 22 toward the exit end 23. That is, in the direction of the optical axis of the periodically poled waveguide 20, the length of a region in which polarization is set in one direction is constant, and the width of the core 21 oriented perpendicularly to the direction of the optical axis becomes gradually smaller from the entrance end 22 toward the exit end 23.

As described above, in the direction toward the exit end at which the intensity of the converted wave propagating inside is higher, the temperature of the waveguide becomes higher. Due to the temperature-induced change caused in the refractive index by the heat generation, the phase matching condition collapses. Therefore, this embodiment provides a periodically poled waveguide in which the structure of the core changes in the optical axis direction so as not to break the phase matching condition expressed in (Equation 4) as approaching the exit end from the entrance end. With this structure, phase mismatch due to light absorption in the waveguide and the heat generation accompanying the light absorption is reduced, and converted waves can be generated with high efficiency.

Note that, even if the composition ratio or the refractive index of the material of the cladding or the material of the core in the periodically poled waveguide is changed gradually in the direction from the entrance end toward the exit end, the same effect is achieved. This is because even if the composition ratio or the refractive index is changed, the phase matching condition shown in (Equation 4) can be maintained. Thus, phase mismatch due to heat generation can be reduced, and the decrease caused in the wavelength conversion efficiency by the phase mismatch can be reduced.

The material that forms an optical waveguide is selected from among nonlinear optical materials including dielectric materials and semiconductors such as silicon (Si), silicon dioxide (SiO₂), lithium niobate (LiNbO₃), lithium tantalate (LiTaO₃), indium phosphorus (InP), and polymers, and compounds and the like obtained by adding an additive to these materials.

### First Embodiment

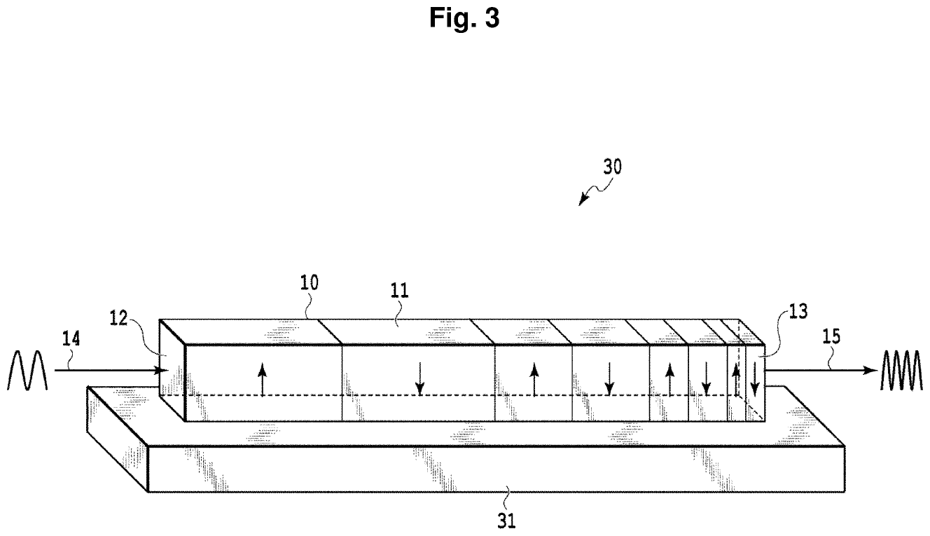

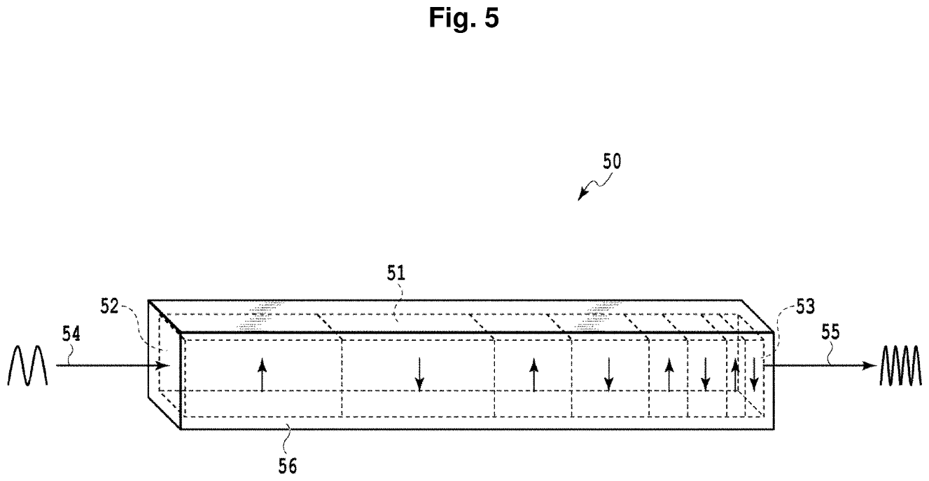

Referring now to FIGS. 3 and 5, a first embodiment according to the present invention is described. This embodiment relates to a wavelength conversion element in which the polarization inversion period changes gradually in the core of a nonlinear optical waveguide in the direction toward the exit end, or, in other words, the length of a region in which polarization is set in one direction changes gradually in the direction of the optical axis of the waveguide.

FIG. 3 is a diagram illustrating a wavelength conversion optical element having a structure in which the polarization inversion period is gradually changed according to an embodiment of the present invention. A wavelength conversion optical element 30 according to this embodiment includes the periodically poled waveguide 10 illustrated in FIG. 1, and a substrate 31 bonded to the lower surface of the core 11 included in the periodically poled waveguide 10, and has a structure in which the polarization inversion period becomes gradually shorter from the entrance end 12 toward the exit end 13. That is, in the direction of the optical axis of the periodically poled waveguide 10, the length of a region in which polarization is set in one direction becomes gradually shorter from the entrance end 12 toward the exit end 13. Here, a LiNb₀₃-based ferroelectric material is used for the core 11, and is bonded directly to the substrate 31 formed with LiTaO₃. Such a wavelength conversion optical element is designed so that light in a wavelength band of 1.5 μm is converted into light in the vicinity of the wavelength of 775 μm of the second harmonic.

In the wavelength conversion optical element according to this embodiment designed as described above, quasi phase matching for periodically inverting polarization is used for phase matching. As described above, the polarization inversion period in this embodiment is designed such that phase matching is performed at a desired wavelength in the vicinity of the entrance end 12, and the length of a region in which polarization is set becomes shorter in the direction toward the exit end 13. This corresponds to shifting the phase matching wavelength to the short-wavelength side in a case where a LiNbO₃-based nonlinear optical waveguide is used. In the wavelength conversion optical element using a LiNbO₃-based ferroelectric material, the phase matching wavelength shifts to the long-wavelength side as the temperature rises. Thus, by adopting such a mode, it becomes possible to reduce phase mismatch due to heat generation, and generate converted waves with high efficiency.

The wavelength conversion optical element in which the polarization inversion period in the core 11 is gradually changed in the direction from the entrance end 12 toward the exit end 13 as described above is not limited to the one in a case where a LiNbO₃-based ferroelectric material is used for the core 11. Accordingly, this embodiment can also be applied to a periodically poled waveguide that uses another nonlinear optical material for the core 11, and the phase matching condition is also maintained therein, to achieve the effect of reducing the phase mismatch due to heat generation and generating converted waves with high efficiency.

Wavelength conversion efficiencies were compared between a conventional wavelength conversion optical element that did not adopt this embodiment and was designed so that the phase matching condition was uniform in the propagation direction of the waveguide, and the wavelength conversion optical element according to this embodiment. As a result, in a case where a fundamental wave of several tens of mW was input, the conventional wavelength conversion optical element exhibited the higher wavelength conversion efficiency. However, in a case where a fundamental wave of several W was input, the wavelength conversion optical element according to this embodiment exhibited the higher wavelength conversion efficiency. This indicates that this embodiment maintained the phase matching condition in the waveguide, and managed to prevent a temperature rise in the element.

Although a ridge optical waveguide in which the core is bonded directly onto the substrate has been described as an example waveguide in the above embodiment, the same effects can be achieved with a buried waveguide as mentioned above. In the case of a buried waveguide, a cladding 56 that covers the periphery of a core 51 in the waveguide is provided as illustrated in FIG. 5.

### Second Embodiment

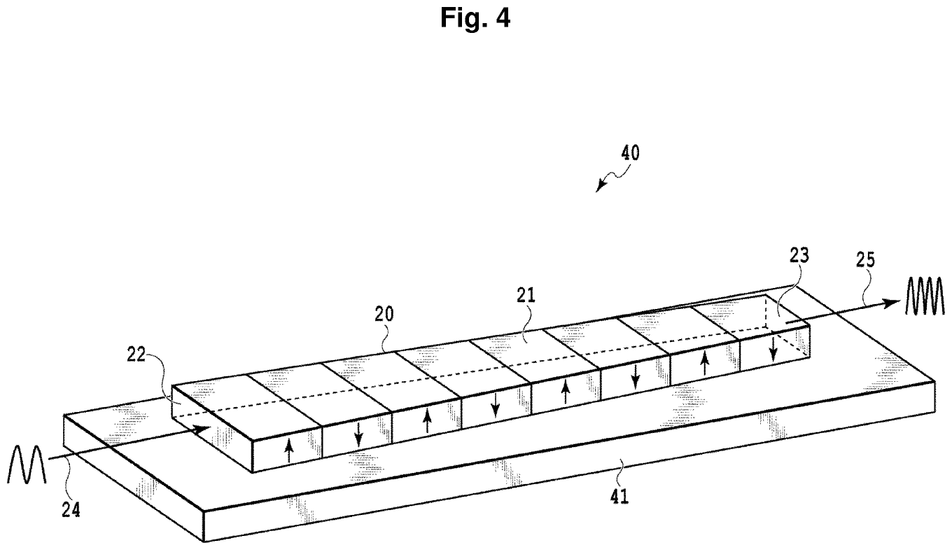

Referring now to FIG. 4, a second embodiment according to the present invention is described. This embodiment relates to a wavelength conversion optical element in which the width of the core changes gradually in the core of a nonlinear optical waveguide in the direction toward the exit end, or, in other words, the core width oriented perpendicularly to the direction of the optical axis changes gradually in the direction of the optical axis of the waveguide.

FIG. 4 is a diagram illustrating a wavelength conversion optical element in which the width of the core is gradually changed according to an embodiment of the present invention. A wavelength conversion optical element 40 according to this embodiment includes the periodically poled waveguide 20 illustrated in FIG. 2, and a substrate 41 bonded to the lower surface of the core 21 included in the periodically poled waveguide 20, and has a structure in which the width of the core 21 becomes gradually smaller from the entrance end 22 toward the exit end 23. That is, in the direction of the optical axis of the periodically poled waveguide 20, the length of a region in which polarization is set in one direction is constant, and the width of the core 21 oriented perpendicularly to the direction of the optical axis becomes gradually smaller from the entrance end 22 toward the exit end 23. As in the first embodiment, a LiNbO₃-based ferroelectric material is used for the core 21 of the wavelength conversion optical element herein, and the core 21 is bonded directly to the substrate 41 formed with LiTaO₃. Such a wavelength conversion optical element is designed so that light in a wavelength band of 1.5 μm is converted into light in the vicinity of the wavelength of 775 μm of the second harmonic.

In the wavelength conversion optical element according to this embodiment designed as described above, quasi phase matching for periodically inverting polarization is used for phase matching, as in the first embodiment. Also, the polarization inversion period is designed so that phase matching is performed at a desired wavelength near the entrance end face. However, this embodiment differs from the first embodiment in that the polarization inversion period of the core 21 is constant, or, in other words, the lengths of the regions in which polarization is set in one direction are equal in the direction of the optical axis of the periodically poled waveguide 20. This corresponds to shifting the phase matching wavelength to the short-wavelength side in a case where a LiNbO₃-based nonlinear optical waveguide is used. Accordingly, by adopting such a mode, it becomes possible to achieve the same effects as those of the first embodiment, and generate converted waves with high efficiency.

The wavelength conversion optical element in which the width of the core 21 is changed in the direction from the entrance end 22 toward the exit end 23 as described above is not limited to the one in a case where a LiNbO₃-based ferroelectric material is used for the core 21. Accordingly, the same effects can also be achieved with a wavelength conversion optical element that uses another nonlinear optical material for the core 21. Whether the width of the core 21 is made shorter or whether the width is made longer in the direction from the entrance end 22 toward the exit end 23 depends on the nonlinear optical material or the structure of the element. Therefore, the change in the width of the core 21 is preferably designed so as to cancel the phase mismatch caused by a temperature rise in the element.

Wavelength conversion efficiencies were compared between a conventional wavelength conversion optical element that did not adopt this embodiment and was designed so that the phase matching condition was uniform in the propagation direction of the waveguide, and the wavelength conversion optical element according to this embodiment. As a result, in a case where a fundamental wave of several tens of mW was input, the conventional wavelength conversion optical element exhibited the higher wavelength conversion efficiency. However, in a case where a fundamental wave of several W was input, the wavelength conversion optical element according to this embodiment exhibited the higher wavelength conversion efficiency. This indicates that this embodiment reduced the temperature rise of the element.

### Third Embodiment

A third embodiment of the present invention is now described below. This embodiment relates to a wavelength conversion optical element in which the refractive index of the core of a nonlinear optical waveguide changes gradually in the direction toward the exit end, or, in other words, the core has a refractive index that varies with each one polarization inversion period, and the refractive indexes in the respective regions vary gradually in the direction of the optical axis of the waveguide.

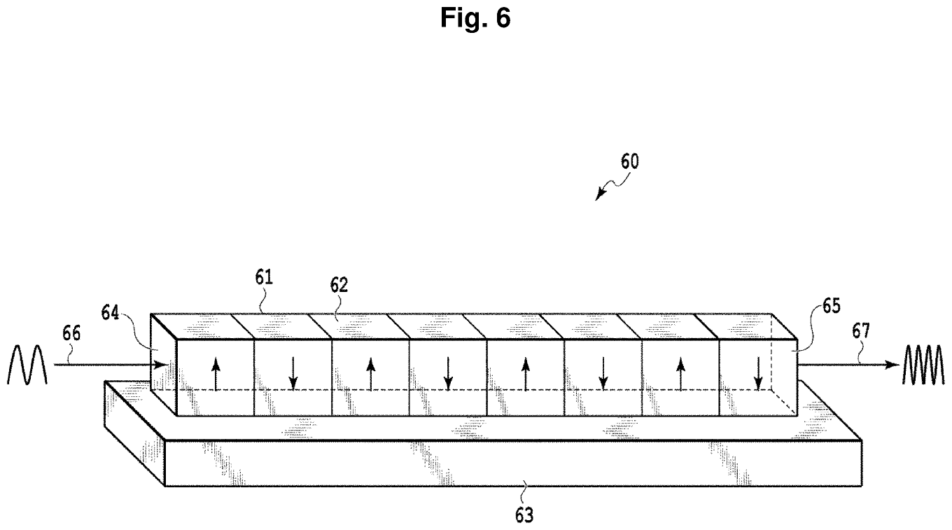

FIG. 6 is a diagram illustrating a wavelength conversion optical element in which the refractive index of the core is gradually changed according to an embodiment of the present invention. A wavelength conversion optical element 60 according to this embodiment includes a periodically poled waveguide 61, and a substrate 63 bonded to the lower surface of the core 62 included in the periodically poled waveguide 61, and has a structure in which the refractive index of the core 62 becomes gradually smaller from the entrance end 64 toward the exit end 65. That is, the core has a different refractive index for each polarization inversion period, and has a structure in which the refractive indexes in the respective regions become gradually smaller from the entrance end 64 toward the exit end 65 in the direction of the optical axis of the waveguide. Such a gradual change in the refractive index is achieved by changing the composition ratio of the material used for the core. As in the first embodiment, a LiNbO₃-based ferroelectric material is used for the core 62 of the wavelength conversion optical element herein, and the core 62 is bonded directly to the substrate 63 formed with LiTaO₃. Such a wavelength conversion optical element is designed so that light in a wavelength band of 1.5 μm is converted into light in the vicinity of the wavelength of 775 μm of the second harmonic.

In the wavelength conversion optical element according to this embodiment designed as described above, quasi phase matching for periodically inverting polarization is used for phase matching, as in the first and second embodiments. Also, the polarization inversion period is designed so that phase matching is performed at a desired wavelength near the entrance end face. However, this embodiment differs from the first embodiment in that the polarization inversion period of the core 62 is constant, or, in other words, the lengths of the regions in which polarization is set in one direction are equal in the direction of the optical axis of the periodically poled waveguide. Further, this embodiment differs from the second embodiment in that the width of the core oriented perpendicularly to the optical axis direction as opposed to the direction of the optical axis of the core 62 is also constant. This corresponds to shifting the phase matching wavelength to the short-wavelength side in a case where a LiNbO₃-based nonlinear optical waveguide is used. Accordingly, by adopting such a mode, it becomes possible to achieve the same effects as those of the first embodiment and the second embodiment, and generate converted waves with high efficiency.

Although the refractive index of the core in a ridge optical waveguide is gradually changed in this embodiment, the refractive index of the cladding in a buried waveguide may be gradually changed, or the refractive indexes of both the core and the cladding may be gradually changed. Further, although the composition ratio is changed so as to change the refractive index in this embodiment, some other material may be adopted so as to change the refractive index. In designing the structure of such an element, it is preferable to design the structure so as to cancel phase mismatch due to a temperature rise in the element.

Wavelength conversion efficiencies were compared between a conventional wavelength conversion optical element that did not adopt this embodiment and was designed so that the phase matching condition was uniform in the propagation direction of the waveguide, and the wavelength conversion optical element according to this embodiment. As a result, in a case where a fundamental wave of several tens of mW was input, the conventional wavelength conversion optical element exhibited the higher wavelength conversion efficiency. However, in a case where a fundamental wave of several W was input, the wavelength conversion optical element according to this embodiment exhibited the higher wavelength conversion efficiency. This indicates that this embodiment maintained the phase matching condition in the waveguide, and managed to reduce the phase mismatch due to heat generation.

### INDUSTRIAL APPLICABILITY

As a technology for generating high-intensity converted waves with high efficiency, the present invention is expected to be applied in the field of optical communication, the field of quantum information communication using light, and the field of optical measurement systems.

1. A wavelength conversion optical element comprising a periodically poled waveguide,
wherein the periodically poled waveguide includes:
a core that performs wavelength conversion on a fundamental wave that has entered an entrance end, and emits a converted wave from an exit end; and
a cladding that covers a periphery of the core, and
a structure of the element gradually changes to achieve quasi phase matching from the entrance end toward the exit end in the periodically poled waveguide.

2. The wavelength conversion optical element according to claim 1, wherein the periodically poled waveguide has a structure in which a length of a region in which polarization is set in one direction in an optical axis direction of the periodically poled waveguide gradually changes in a direction from the entrance end toward the exit end.

3. The wavelength conversion optical element according to claim 1, wherein the periodically poled waveguide has a structure in which
a length of a region in which polarization is set in one direction in an optical axis direction of the periodically poled waveguide is constant, and
a width of the core oriented perpendicularly to the optical axis direction gradually changes in a direction from the entrance end toward the exit end.

4. The wavelength conversion optical element according to claim 1, wherein a refractive index of the periodically poled waveguide gradually changes in a direction from the entrance end toward the exit end.

5. The wavelength conversion optical element according to claim 4, wherein a composition ratio of a material used in the periodically poled waveguide gradually changes in the direction from the entrance end toward the exit end.

6. The wavelength conversion optical element according to claim 4, wherein a material used in the periodically poled waveguide gradually changes in the direction from the entrance end toward the exit end.

7. The wavelength conversion optical element according to claim 1, wherein the cladding includes an air layer.
